(19) United States
(12) Patent Application Publication
(10) Pub. No.: US 2002/0116311 A1
(43) Pub. Date: Aug. 22, 2002

(54) Method of managing financial investments on a group basis

(75) Inventors: Shane A. Chalke, Leesburg, VA (US); Steven J. Dunlap, Leesburg, VA (US)

Correspondence Address: Daniel R. Gropper, PC, 9908 Dale Ridge Ct., Vienna, VA, 22181, US

(73) Assignee: AnnuityNet, Inc., Leesburg, VA

(21) Appl. No.: 10/082,470

(22) Filed: Feb. 21, 2002

Related U.S. Application Data
(60) Provisional application No. 60/270,412, filed on Feb. 21, 2001.
(60) Provisional application No. 60/275,145, filed on Mar. 13, 2001.

(51) Int. Cl. G06F 17/60

(52) U.S. Cl. 705/36

(57) ABSTRACT

A group trading software application and method for remotely based investment managers providing the capability for managing multiple investment accounts by user defined groups. The groups can contain multiple investment and subgroups, each of which can be defined by the user around such criteria as on an ad hoc basis, on common levels of risk and by groups of owners. Multiple trading day fund cut off times for each group or subgroup are supported. Pending and complete trade status for each individual account, groups and/or subgroup is provided. The investments can be in any financial product, including annuities, mutual funds and insurance policies.

### FIELD OF THE INVENTION

An annuity is a contract, sold by a commercial insurance company, that permits the contract owner thereof to accumulate assets that can be used, at a time selected by the contract owner, to pay benefits to the contract owner on a regular basis for the remainder of the annuitant's life or for another specified period of time. Generally the annuitant and contract owner are the same person. The amount of each payment received depends on the performance of the investments made by the contract owner or his/her manager. Underlying each annuity contract are investments in mutual funds, called subaccounts, which in turn invest in stocks, bonds, commercial paper, and government and agency obligations. Investments can also often be made in the insurance company's general account with the insurance company guaranteeing the amount so invested and interest for such investment. Annuity managers regularly rebalance the amount of annuity contract money invested in each type of investment in response to current financial conditions and in anticipation of distributions from the investments. Until the present invention, each annuity manager had to enter the same information to rebalance, change or modify each investment for each separate annuity contract. This has been a time consuming, expensive and error prone area of annuity management. The methods taught herein are applicable to most financial transactions involving mutual funds, insurance and other financial vehicles.

There are many patents in the field of financial management, but none disclose, alone or in combination, the methods of the instant invention used to manage groups of annuity or financial contracts. For example, many patents teach generalized financial tracking and planning methods including U.S. Pat. No. 5,644,727 to Atkins; U.S. Pat. No. 5,745,706 to Wolfberg; and U.S. Pat. No. 5,844,285 to Atkins. U.S. Pat. No. 5,819,230 to Christie et al. teaches a method for handling mortgage and life insurance accounts. U.S. Pat. No. 5,926,792 teaches a back office administration method for life insurance administration. U.S. Pat. No. 6,064,986 to Edelman and U.S. Pat. No. 6,085,174 to Edelman teach a computer-assisted method for maintenance of a customer investment and retirement program. U.S. Pat. No. 6,275,807 to Schirripa teaches a back office for annuity management and insurance company.

### SUMMARY OF THE INVENTION

An object of the instant invention is to provide a method for an annuity or financial manager to enter the desired information once for a defined group of annuity or financial contracts and for that information to be parsed to the individual contract, forwarded to, and acted on by financial institutions.

Another object of the instant invention is to provide a method that after individual contract information from the financial institution is recompiled into the annuity manager's defined groups, the results of the transaction is made available to the account manager, often automatically.

Another object of the instant invention is to provide an automated process for the entire group annuity or financial vehicle maintenance sequence, including the ability to execute group trades and re-balancing at pre-determined time intervals.

### DESCRIPTION OF THE PREFERRED EMBODIMENTS

The managing of individual annuities or other financial investments is a time consuming and expensive business. To be efficient, the annuity or financial manager needs to be able to quickly and efficiently make decisions and trades for large numbers of individual annuity contracts simultaneously.

Annuity contracts are handled on a contract by contract basis by financial institutions. The instant invention addresses the needs of the annuity manager to handle multiple annuity contracts on a group basis, while having access to the details of each individual contract, and of the financial institutions need to handle each contract on an individual basis.

It will be understood that the instant method will be applicable to new technologies hereinafter developed and may be performed on one or more computers that may be co-located or may be located at remote locations, without departing from the nature or spirit of this invention. The terms first computer system, second computer system, and financial institution computer system, as used herein, are meant to represent block diagramatic computer systems, which may physically be one or more computer systems and/or may be connected by any presently known, or developed in the future, communication system, such as the current world wide internet connection.

In one preferred embodiment, there will be a first computer system that can automatically contact a financial institution's computer system enabling the execution of transactions on the financial institution's computer system. Individual contract or annuity information and transaction information is made available to, and transaction information is received by, the first computer system from the financial institution's computer system.

A second computer system is connected to the first computer system. Managers of annuities have access to the second computer system and enter instructions and receive status reports from the financial institution's computer system about individual or group annuity transaction through the first computer system.

Managers of annuities can define, on the second computer system, groups of multiple annuities on which the annuity manager wishes to execute the same set of instructions.

The same set of instructions for a group of annuities is sent from the second computer to the first computer. The first computer decompiles the instructions affecting a group of annuities into instructions for individual annuities and then forwards the separate instruction to the financial institution's computer to execute the instructions. The financial institution's computer then responds back to the first computer system with the results of the annuity contract and/or financial information about the transaction. The first computer then recompiles the transaction information back into the groups of annuity contracts defined by the annuity manager. This information is then forwarded from the first computer to the second computer. The annuity manager can then access the results of the transaction for both groups of annuities and for individual annuities within each group from the second computer system.

The management of a group of annuities is further complicated by the differing trade cut off times for different investments and different financial institutions. The instant invention tracks the daily trade cut off time and automatically advises the annuity or financial manager when trading on any investment of interest has closed for the day. The instant invention can also permit the annuity manager to automatically or manually request that a re-allocation, or part of a reallocation be canceled, modified or otherwise amended before the daily trading cut off time for individual or groups of annuities.

Many annuities must maintain predetermined account balances across various investments, which is complicated as the values of the various investments change. The instant invention permits automatic investment re-balancing to achieve and maintain preset allocation goals on multiple bases such as to achieve a one time target account re-allocation; a one time target re-allocation to transfer all or a portion of the money from one or more investments and distribute it amongst one or more other investments by target percentages; execute regular, and pretimed targeted re-allocations, including to transfer all or a portion of the money from one or more investments and to redistribute it amongst other investments by target percentages.

Using the system taught by the instant invention, the annuity manager, through instructions input into the second computer, can modify, cancel, and/or adjust the investment allocation supporting multiple annuities with one set of instructions. Before the instant invention, each annuity contract would need to be individually re-balanced, which would be quite time and money consuming and prone to errors.

With each transaction, the financial institution's computer generates status reports on the allocations of investments managed by that financial institution. The status information is then automatically forwarded to the first computer system and is combined with financial account status information from the other financial institution. This entire group of information is then automatically recompiled and indexed against each individual annuity contract and then into the annuity manager's groups of annuities. This re-compiled information is then forwarded to the second computer in a format so that the annuity manager can access information for each investment, within each annuity contract, and within each annuity manager's group. The above transactions can occur without human intervention, which greatly speeds the transaction time for each re-allocation and reduces the chances for error in the execution of the re-allocation.

For trades, the first computer automatically checks to see that each member of the annuity manager defined group shares at least one common financial characteristic in order for the instant invention to be able to execute the change on each common element. For trades, if there is not a common element, a proper group has not been identified by the annuity manager. For transactions other than trades a common element is not required.

The first computer also verifies that each individual contract does not have an outstanding trade placed against that contract which would negatively impact the trade for that group of annuities. These error-checking features of the instant invention make the entire annuity management process more efficient.

The annuity or financial manager can form groups of annuities on an ad hoc, as needed basis, or can define standing groups of annuity contracts, such as those contracts which accept high risk, or which must be maintained as low risk. The first computer can be programmed to issue error messages when re-allocations that would violate the group criteria are requested. This feature of the instant invention improves the reliability of the re-allocation process and provides a back up for the instructions of the annuity manager.

It is to be understood that while certain forms of the present invention have been described herein, it is not to be limited to the specific forms or arrangement of method described and shown and herein and other forms of the invention can be practiced as taught herein without departing from the nature and spirit of the invention.

What we claim is:

1. A system for remotely and automatically managing group based investment allocation comprising:
a) a first computer system, wherein said first computer system can automatically connect to other financial institution's computer systems and execute financial trades on said other financial institution's computer systems, and receive account trading status reports back from said other financial institution's computer systems;
b) a second computer system, connected to said first computer system, wherein managers of investment accounts can enter instructions and receive status reports on the status of the investments making up the investment group from said financial institution's computers through said first computer system and then through said second computer system;
c) wherein said managers of said investment accounts can define, on said second computer system, groups of multiple investments, on which said manager desires to execute a set of trade instructions;
d) wherein, said set of trade instructions, from said second computer, concerning each of said managers of said investment accounts defined group of investment, is received by said first computer system;
e) wherein, said first computer system automatically organizes said same set of trade instructions for a group of investment accounts into separate instructions for each individual investment account and transmits said instructions to said financial institution's computer system for each said individual investment account;
f) wherein, said financial institutions computer system responds back to said first computer system with the results of each individual trade; and,
g) wherein said first computer system recompiles said information from each individual trade into said user defined group and forwards said information to said second computer system, wherein said managers can view said results on an individual account or on a group account basis.

2. A system for remotely and automatically managing group based investment allocation, as recited in claim 1, further comprising definable trading day cut off times for each investment.

3. A system for remotely and automatically managing group based investment allocation, as recited in claim 1, wherein said managers of said investment accounts can, through said second computer system, automatically execute a target account re-allocation.

4. A system for remotely and automatically managing group based investment allocation, as recited in claim 1, wherein said managers of said investment accounts can, through said second computer system, automatically execute a target account transfer of all money from one or more investments and distribute it amongst one or more other investments by target percentages.

5. A system for remotely and automatically managing group based investment allocation, as recited in claim 1, wherein said managers of said investment accounts can, through said second computer system, automatically execute regular, pre-timed target account transfer of all money from one or more investments and distribute it amongst one or more other investments by target percentages.

6. A system for remotely and automatically managing group based investment allocation, as recited in claim 1, wherein said managers of said investment accounts can, through said second computer system, modify, cancel or adjust multiple investments at one time.

7. A system for remotely and automatically managing group based investment allocation, as recited in claim 1, wherein said managers of said investments can, through said second computer system, automatically prepare client status reports for a group of contracts, with details on each individual contract.

8. A system for remotely and automatically managing group based investment allocation, as recited in claim 1, wherein said managers of said investment accounts can, through said second computer system, automatically conduct multiple transactions on individual accounts within groups of accounts without human intervention.

9. A system for remotely and automatically managing group based investment allocation, as recited in claim 1, wherein each transaction is automatically checked to ensure that contracts in a group have at least one financial position in common for trades.

10. A system for remotely and automatically managing group based investment allocation, as recited in claim 1, wherein each transaction is automatically checked to ensure that individual contracts do not have outstanding trades placed on them that would negatively impact the trade for that group.

11. A system for remotely and automatically managing group based investment allocation, as recited in claim 1, wherein said managers of said investment accounts can, through said second computer system, form ad-hoc groups of contracts.

12. A system for remotely and automatically managing group based investment allocation, as recited in claim 1, wherein said managers of said investment accounts can, through said second computer system, form standing groups of contracts.

13. A system for remotely and automatically managing group based investment allocation, as recited in claim 1, wherein said managers of said investment accounts can, through said second computer system, automatically cancel or modify transactions on individual accounts within groups of accounts before trade cut off time.

14. A system for remotely and automatically managing group based investment allocation, as recited in claim 1, wherein said first computer system and said second computer system are physically one computer system.

15. A system for remotely and automatically managing group based investment allocation, as recited in claim 1, wherein said first computer system and said second computer system are computer systems in a server and client relationship, respectively.

16. A system for remotely and automatically managing group based investment allocation, as recited in claim 1, wherein the financial group investment is in the form of mutual funds.

17. A system for remotely and automatically managing group based investment allocation, as recited in claim 1, wherein the financial group investment is in the form of annuities.

18. A system for remotely and automatically managing group based investment allocation, as recited in claim 1, wherein the financial group investment is in the form of insurance.

19. A system for remotely and automatically managing group based investment allocation, as recited in claim 1, wherein said first computer system and said second computer system are physically multiple separate computer systems.
